(19) United States
(12) Patent Application Publication
(10) Pub. No.: US 2025/0199165 A1
(43) Pub. Date: Jun. 19, 2025

(54) APPARATUS AND METHOD FOR RECOGNIZING NEARBY OBJECT IN PERSONAL MOBILITY DEVICE

(71) Applicant: HL KLEMOVE CORPORATION, Incheon (KR)

(72) Inventor: Ye-Chan JANG, Incheon (KR)

(21) Appl. No.: 18/909,693

(22) Filed: Oct. 8, 2024

(30) Foreign Application Priority Data
Dec. 13, 2023 (KR) 10-2023-0180986
Apr. 23, 2024 (KR) 10 -2024-0054087

(51) Int. Cl. G01S 13/931; B60W 50/14; H04W 4/02; H04W 4/80

(52) U.S. Cl. CPC G01S 13/931; B60W 50/14; H04W 4/027; H04W 4/80; G01S 2013/9316; G01S 2013/932

(57) ABSTRACT

Provided are a method and an apparatus for recognizing a nearby object, the apparatus including: a memory including at least one instruction; and at least one processor configured to execute the at least one instruction stored in the memory, wherein the processor is configured to generate first surrounding information including an object detected by a radar sensor, and integrate the first surrounding information with second surrounding information received from at least one other personal mobility device through a short-range communication network to generate a notification message related to at least one object, the method and apparatus being employable for other embodiments.

### CROSS-REFERENCE TO RELATED APPLICATION

This application claims priority to and the benefit of Korean Patent Application No. 10-2023-0180986, filed on Dec. 13, 2023, and Korean Patent Application No. 10-2024-0054087 filed Apr. 23, 2024, and the disclosure of which is incorporated herein by reference in its entirety.

### BACKGROUND

### Technical Field

The present disclosure relates to an apparatus and method for recognizing a nearby object in a personal mobility device.

### Description of Related Art

As low-carbon green growth has emerged as a major global issue, eco-friendly transporters having no environmental pollution or carbon emissions have been actively researched. In addition, due to the era-specific factors of high oil prices and a global economic downturn, there is an increasing demand for low-cost transporters. In addition, people are becoming more interested in health, and traffic congestion is increasing, which is leading to an increase in the distribution of convenient personal mobility devices.

However, unlike automobiles, such a personal mobility device is not equipped with sensors to detect objects that are located in front of or beside the personal mobility device, and thus there is a limitation for a user in recognizing objects at the corners where the user does not have a clear view. Accordingly, accidents frequently occur due to objects that are not visually recognized by users.

Accordingly, there is an emerging need for the development of technology that enables users to recognize objects which are not visually perceived while using personal mobility devices and thus reduce accident rates.

### BRIEF SUMMARY

The present disclosure is directed to providing an apparatus and method for recognizing a nearby object in a personal mobility device that are capable of integrating information about an object obtained from other personal mobility devices using a radar sensor and a short-range communication network and identifying the information.

The present disclosure is directed to providing an apparatus and method for recognizing a nearby object in a personal mobility device that are capable of integrating information about an object obtained from other personal mobility devices through a short-range wireless communication network formed using Bluetooth Low Energy (BLE), and identifying the information.

According to an aspect of the present disclosure, there is provided an apparatus for recognizing a nearby object, the apparatus including: a memory in which at least one instruction is stored; and at least one processor configured to execute the at least one instruction stored in the memory, wherein the processor is configured to generate first surrounding information including an object detected by a radar sensor, and integrate the first surrounding information with second surrounding information received from at least one other personal mobility device through a short-range communication network to generate a notification message related to at least one object.

The processor may identify a current location of a personal mobility device.

The processor may identify a moving direction and a moving speed of the personal mobility device.

The first surrounding information and the second surrounding information may include the current location, the moving direction, and the moving speed, include location information of the object identified based on the current location and the moving direction, and include a unique number assigned to the radar sensor.

The short-distance communication network may be a mesh network formed based on Bluetooth Low Energy (BLE).

Upon the same unique number being identified when integrating the first surrounding information with the second surrounding information, the processor may delete surrounding information other than most recently received surrounding information.

The processor may identify equivalence of an object based on the location information of the object included in the first surrounding information and the second surrounding information.

When at least one object is identified as the same object based on the location information of the object, the processor may merge the at least one object into one object.

The processor may transmit the integrated surrounding information to at least one other personal mobility device located within a range of the short-range communication network.

The processor may generate the notification message when the at least one object is determined to be a dangerous object based on the current location, the moving direction, and the moving speed of the personal mobility device.

According to an aspect of the present disclosure, there is provided a method of recognizing a nearby object, the method including: generating, by a processor, first surrounding information including an object detected by a radar sensor; receiving, by the processor, second surrounding information from at least one other personal mobility device through a short-range communication network; integrating, by the processor, the first surrounding information with the second surrounding information; and generating, by the processor, a notification message related to at least one object identified based on the integrated surrounding information.

The generating of the first surrounding information may include identifying a current location of a personal mobility device.

The generating of the first surrounding information may include identifying a moving direction and a moving speed of the personal mobility device.

The generating of the first surrounding information may include generating the first surrounding information including: the current location, the moving direction, and the moving speed; location information of the object identified based on the current location and the moving direction; and a unique number assigned to the radar sensor.

The receiving of the second surrounding information may include receiving the second surrounding information through a mesh network formed based on Bluetooth Low Energy (BLE), which is the short-distance communication network.

The integrating of the first surrounding information with the second surrounding information may include, upon the same unique number being identified when integrating the first surrounding information with the second surrounding information, deleting surrounding information other than most recently received surrounding information.

The integrating of the first surrounding information with the second surrounding information may include identifying equivalence of an object based on the location information of the object included in the first surrounding information and the second surrounding information.

The integrating of the first surrounding information with the second surrounding information may include, when at least one object is identified as the same object based on the location information of the object, merging the at least one object into one object.

The method may further include, after the integrating of the first surrounding information with the second surrounding information, transmitting, by the processor, the integrated surrounding information to at least one other personal mobility device located within a range of the short-range communication network.

The generating of the notification message may include generating the notification message when the at least one object is determined to be a dangerous object based on the current location, the moving direction, and the moving speed of the personal mobility device.

### BRIEF DESCRIPTION OF THE SEVERAL VIEWS OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating main configurations of a system for recognizing a nearby object according to an embodiment of the present disclosure;

FIG. 2 is a diagram illustrating main configurations of a radar apparatus for recognizing a nearby object according to an embodiment of the present disclosure;

FIG. 3 is a flowchart for describing a method of recognizing a nearby object according to an embodiment of the present disclosure;

FIG. 4 is an exemplary diagram for describing a method of generating integrated surrounding information according to an embodiment of the present disclosure;

FIG. 5 is a diagram illustrating main configurations of a system for recognizing a nearby object according to another embodiment of the present disclosure; and

FIG. 6 is a diagram illustrating main configurations of an electronic apparatus for recognizing a nearby object according to another embodiment of the present disclosure.

### DETAILED DESCRIPTION

Hereinafter, exemplary embodiments according to the present disclosure will be described in detail with reference to the accompanying drawings. The following detailed description set forth below in conjunction with the accompanying drawings is intended to illustrate exemplary embodiments of the disclosure and is not intended to represent the only embodiments in which the disclosure may be practiced. In the drawings, parts irrelevant to the description may be omitted for the clarity of explanation, and like numbers refer to like elements throughout the description of the drawings.

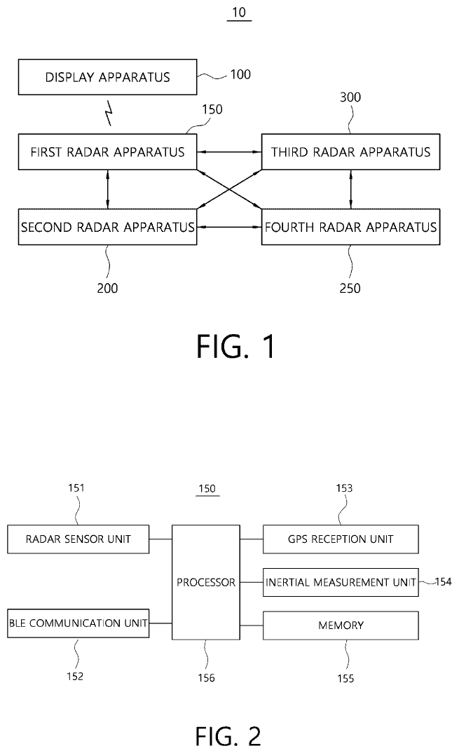

FIG. 1 is a diagram illustrating main configurations of a system for recognizing a nearby object according to an embodiment of the present disclosure.

Referring to FIG. 1, a system 10 according to the present disclosure may include a display apparatus 100 and a plurality of radar apparatus 150, 200, 250, and 300, and the display apparatus 100 may be connected to the first radar apparatus 150. In this case, the display apparatus 100 and the first radar apparatus 150 may be formed as a pair installed in one personal mobility device (not shown). The second radar apparatus 200 to the fourth radar apparatus 300 may also be connected to respective display apparatus, similarly to the first radar apparatus 150, and may be provided in second to fourth personal mobility devices, respectively. Accordingly, since the radar apparatus also move according to the movement of the personal mobility devices, in describing the embodiment of the present disclosure, the first personal mobility device to the fourth personal mobility device are used interchangeably with the first radar apparatus 150 to the fourth radar apparatus 300, respectively, for convenience.

The display apparatus 100 is provided in the first personal mobility device and communicates with the first radar apparatus 150. To this end, the display apparatus 100 may perform wireless communication with the first radar apparatus 150 through BLE communication, and may perform wired communication by being connected to the first radar apparatus 150 by wire. The display apparatus 100 may receive a notification message that is received from the first radar apparatus 150, and may display the received notification message. In this case, the notification message may be a message for providing information about an object located in the direction of movement of the personal mobility device but not detected by the first radar apparatus 150.

The first radar apparatus 150 generates first surrounding information including at least one object detected by a radar sensor included in the first radar apparatus 150. The first radar apparatus 150 integrates the first surrounding information with second surrounding information received from at least one other radar apparatus through a short-range communication network to generate a notification message related to at least one object. In this case, main configurations of the first radar apparatus 150 will be described in more detail using FIG. 2 below. FIG. 2 is a diagram illustrating main configurations of a radar apparatus for recognizing a nearby object according to an embodiment of the present disclosure.

Referring to FIG. 2, the radar apparatus 150 according to the present disclosure may include a radar sensor unit 151, a Bluetooth Low Energy (BLE) communication unit 152, a Global Positioning System (GPS) reception unit 153, an inertial measurement device 154, a memory 155, and a processor 156. In addition, in the embodiment of the present disclosure, the main configurations shown in FIG. 2 are illustrated as main configurations of the radar apparatus 150, but the second radar apparatus 200 to the fourth radar apparatus 300 may also be implemented with the configurations shown in FIG. 2.

The radar sensor unit 151 is a radio detection and ranging sensor that radiates electromagnetic waves and detects reflected waves that are reflected back from an object. The radar sensor unit 151 may use the detected reflected waves to detect an object located in the direction in which the electromagnetic waves are radiated and measure the distance from the radar sensor unit 151 to the object. The radar sensor unit 151 may identify whether there is at least one object located forward in the moving direction of the first radar apparatus 150 and the distance between the first radar apparatus 150 and the object based on the reflected waves, and transmit a result of the identification to the processor 156.

The BLE communication unit 152 performs communication with the display apparatus 100 using BLE, and forms a BLE mesh network with a plurality of radar apparatus located outside the first radar apparatus 150, such as a second radar apparatus 200 to the fourth radar apparatus 300.

The BLE communication unit 152 may receive second surrounding information from the second radar apparatus 200 to the fourth radar apparatus 300 through BLE communication, and transmit first surrounding information generated by the first radar apparatus 150 to the second radar apparatus 200 to the fourth radar apparatus 300. Additionally, the BLE communication unit 152 may transmit integrated surrounding information, in which the first surrounding information is integrated with the second surrounding information, to the second radar apparatus 200 to the fourth radar apparatus 300.

The GPS reception unit 153 may receive signals transmitted from a GPS satellite, calculate a current location of the user, and transmit the current location of the user to the processor 156.

The inertial measurement device 154 is an inertial measurement unit (IMU) and may include an accelerometer, a gyroscope, a magnetometer, and an altimeter. The inertial measurement device 154 may identify the moving direction and the moving speed of the first radar apparatus 150 and transmit a result of the identification to the processor 156.

The memory 155 may store a plurality of programs for controlling the first radar apparatus 150. The memory 155 may store a unique number assigned to the radar sensor unit 151. The memory 155 may store a program for generating integrated surrounding information by integrating first surrounding information and second surrounding information. In particular, the memory 155 may store a program for identifying the same object in first surrounding information and second surrounding information.

The processor 156 may, when the start of driving of the first personal mobility device is confirmed, identify current location information of the first personal mobility device (hereinafter referred to as the first radar apparatus 150) through communication with the GPS reception unit 153. The processor 156 may identify a current moving direction and a current moving speed of the first radar apparatus 150 through communication with the inertial measurement device 154.

The processor 156 may detect at least one object located in the moving direction of the first radar apparatus 150 based on sensing data from the radar sensor unit 151. The processor 156 generates first surrounding information including the current location information of the first radar apparatus 150, the current moving direction of the first radar apparatus 150, the current moving speed of the first radar apparatus 150, the at least one detected object, and the unique number assigned to the radar sensor unit 151.

The processor 156 may, upon receiving second surrounding information from at least one other personal mobility device through the BLE mesh network, integrate the first surrounding information with the second surrounding information to generate integrated surrounding information. For example, the processor 156 may receive second surrounding information from each of the second radar apparatus 200, the third radar apparatus 250, and the fourth radar apparatus 300 forming a BLE mesh network with the first radar apparatus 150. In this case, the second surrounding information may include current location information, a current moving direction, a current moving speed, and at least one detected object of the second radar apparatus 200 to the fourth radar apparatus 300, and a unique number assigned to the radar sensor unit of each of the radar apparatus 200, 250, and 300.

The processor 156 identifies the unique numbers of the first to fourth radar apparatus 150, 200, 250, and 300 included in the first surrounding information and the second surrounding information. The first surrounding information and the second surrounding information may be updated in real time according to the movement of the first to fourth radar apparatus 150, 200, 250, and 300. When the same unique number is identified when integrating the first surrounding information with the second surrounding information, the processor 156 may delete surrounding information other than the most recently received surrounding information, thereby maintaining the most recent surrounding information.

Additionally, the processor 156 may identify equivalency of an object based on location information of the object included in the first surrounding information and the second surrounding information. The processor 156, when it is identified as a result of identifying the location information of the object included in the first surrounding information and the second surrounding information that objects included in the first surrounding information and the second surrounding information are the same object, merge the objects into one object, and when the objects are not identified to be the same object, maintain the objects as separate objects to generate the integrated surrounding information.

The processor 156, upon identifying a radar apparatus capable of receiving the integrated surrounding information within a range of the BLE mesh network through communication with the BLE communication unit 152, transmits the integrated surrounding information to the identified radar apparatus.

The processor 156 may, when at least one object identified in the integrated surrounding information is determined to be a dangerous object based on the current moving direction and the current moving speed of the first personal mobility device, generate a notification message and transmit the generated notification message to the display apparatus 100.

The second radar apparatus 200 to the fourth radar apparatus 300 form a BLE mesh network through short-range wireless communication with the first radar apparatus 150. The second radar apparatus 200 to the fourth radar apparatus 300 may each generate second surrounding information including location information about at least one object located in the moving direction thereof, and transmit the generated second surrounding information to all radar apparatus included in the BLE mesh network through BLE communication. Additionally, the second radar apparatus 200 to the fourth radar apparatus 300 may receive surrounding information from other radar apparatus and may receive integrated surrounding information from the first radar apparatus 150.

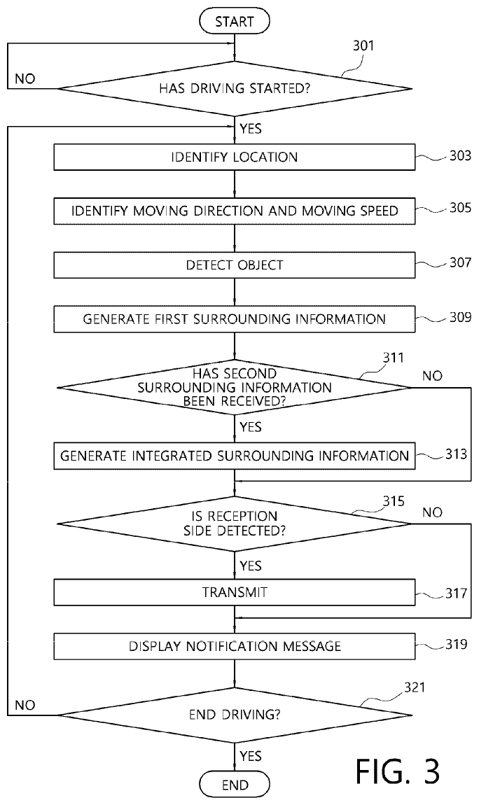

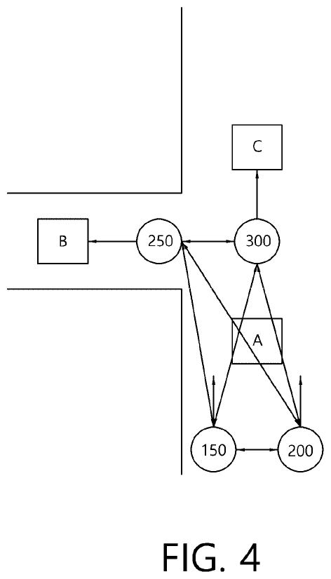

FIG. 3 is a flowchart for describing a method of recognizing a nearby object according to an embodiment of the present disclosure. FIG. 4 is an exemplary diagram for describing a method of generating integrated surrounding information according to an embodiment of the present disclosure.

Referring to FIGS. 3 and 4, in operation 301, the processor 156 identifies whether the first personal mobility device has started driving. When it is identified as a result of the identification in operation 301 that the first personal mobility device has started driving, the processor 156 performs operation 303, and when the first personal mobility device has not started driving, continuously identifies whether the first personal mobility device has started driving. In this case, the processor 156 may identify whether the first personal mobility device has started driving based on real-time change in the location information of the first personal mobility device through communication with the GPS reception unit 153.

In operation 303, the processor 156 may identify current location information of the first personal mobility device (hereinafter referred to as a first radar apparatus 150) through communication with the GPS reception unit 153. In operation 305, the processor 156 may identify a current moving direction and a current moving speed of the first radar apparatus 150 through communication with the inertial measurement device 154.

In operation 307, the processor 156 may detect at least one object located in the moving direction of the first radar apparatus 150 based on sensing data from the radar sensor unit 151. In operation 309, the processor 156 generates first surrounding information including the current location information of the first radar apparatus 150, the current moving direction of the first radar apparatus 150, the current moving speed of the first radar apparatus 150, the at least one detected object, and the unique number assigned to the radar sensor unit 151.

In operation 311, the processor 156 identifies whether second surrounding information has been received from at least one other personal mobility device through a short-range communication network. For this, the short-range communication network may be a BLE mesh network formed through the BLE communication unit 152. When it is identified as a result of the identification in operation 311 that second surrounding information has been received, the processor 156 performs operation 313, and when second surrounding information has not been received, the processor 156 performs operation 315.

For example, the processor 156 may receive second surrounding information from each of the second radar apparatus 200, the third radar apparatus 250, and the fourth radar apparatus 300 that form the BLE mesh network together with the first radar apparatus 150. In this case, the arrow indicated by the dotted line represents the BLE mesh network. In addition, the second surrounding information may include current location information, a current moving direction, a current moving speed, and at least one detected object of the second radar apparatus 200 to the fourth radar apparatus 300, and a unique number assigned to the radar sensor unit of each of the radar apparatus 200, 250, and 300.

In operation 313, the processor 156 generates integrated surrounding information by integrating the first surrounding information with the second surrounding information. More specifically, the processor 156 identifies the unique numbers of the first to fourth radar apparatus included in the first surrounding information and the second surrounding information. The first surrounding information and the second surrounding information may be updated in real time according to the movement of the first to fourth radar apparatus. When the same unique number is identified when integrating the first surrounding information and the second surrounding information, the processor 156 may maintain the most recent surrounding information by deleting surrounding information other than the most recently received surrounding information.

Additionally, the processor 156 identifies equivalency of an object based on location information of the object included in the first surrounding information and the second surrounding information. For example, referring to FIG. 4, the first radar apparatus 150 and the second radar apparatus 200 may be moving in a direction in which object A is located, the third radar apparatus 250 may be moving in a direction in which object B is located, and the fourth radar apparatus 300 may be moving in a direction in which object C is located. In this case, the arrows indicated by a solid line in FIG. 4 may represent the direction of movement of the radar apparatus.

Since the first radar apparatus 150 to the fourth radar apparatus 300 form a BLE mesh network, the first radar apparatus 150 may receive second surrounding information including location information about object A, object B, and object C from the second radar apparatus 200 to the fourth radar apparatus 300.

The processor 156, when it is identified as a result of identification of the location information of the object included in the first surrounding information and the second surrounding information that objects identified by the first radar apparatus 150 and the second radar apparatus 200 are the same as object A, merge the objects identified by each radar apparatus into a single object, object A. For example, the processor 156 may identify the location information of the object based on the moving direction of the first radar apparatus 150 to the fourth radar apparatus 300. More specifically, the processor 156 may identify the current location and the moving direction of the first radar apparatus 150 and identify the distance between the first radar apparatus 150 and the object, and may identify the current location and the moving direction of each of the second radar apparatus 150 to the fourth radar apparatus 300, and the distance between each radar apparatus and the object. Accordingly, the processor 156 may identify the location information of the object identified by each radar apparatus.

The processor 156 may, when it is identified that the location information of the objects identified by the first radar apparatus 150 and the second radar apparatus 200 are similar by a threshold value or more, merge the objects into object A. In addition, the processor 156 may, when it is identified that location information of an object identified by the third radar apparatus 250 is different from location information of object A and location information of an object identified by the fourth radar apparatus 300, identify the object as object B. The processor 156 may, when it is identified that location information of an object identified by the fourth radar apparatus 300 is different from location information of object A and location information of object B, identify the object as object C.

In operation 315, the processor 156 may, when a radar apparatus capable of receiving the integrated surrounding information (hereinafter referred to as integrated surrounding information) within a range of the BLE mesh network is identified through communication with the BLE communication unit 152, perform operation 317, and when no radar apparatus capable of receiving the integrated surrounding information is identified, perform operation 319.

In operation 317, the processor 156 transmits the integrated surrounding information to a radar apparatus present within the range of the BLE mesh network. In this case, the integrated surrounding information may include the location information of object A, the location information of object B, and the location information of object C. Through such a configuration, the second radar apparatus 200 having received the integrated surrounding information may identify that object B is present when turning a corner based on the moving direction of the second radar apparatus 200 and that object C is present when moving straight.

In operation 319, the processor 156 may, when at least one object identified in the integrated surrounding information is determined to be a dangerous object based on the current moving direction and the current moving speed of the first personal mobility device, generate a notification message and transmit the notification message to the display apparatus 100. Referring to FIG. 4, the processor 156 may not detect object B by the radar sensor unit 151 due to the corner, and may not detect object C since electromagnetic waves emitted from the first radar apparatus 150 do not reach object C due to the distance between the first radar apparatus 150 and object C or due to the presence of the fourth radar apparatus 300. In this case, the processor 156 may display a notification message indicating that object B is present when the first radar apparatus 150 turns a corner while moving from the current location, and that object C is present when the first radar apparatus 150 moves straight from the current location. Therefore, users may prepare for dangerous situations. In addition, the processor 156 may calculate the time to reach object B or object C from the current location of the first radar apparatus 150 based on the current moving speed of the first radar apparatus 150, and display the calculated time while displaying the notification message at the same time.

In operation 321, the processor 156, when it is identified that the driving of the first personal mobility devices has ended, ends the process and when the driving of the personal mobility has not ended, returns to operation 303 and repeats the operations of operations 303 to 319.

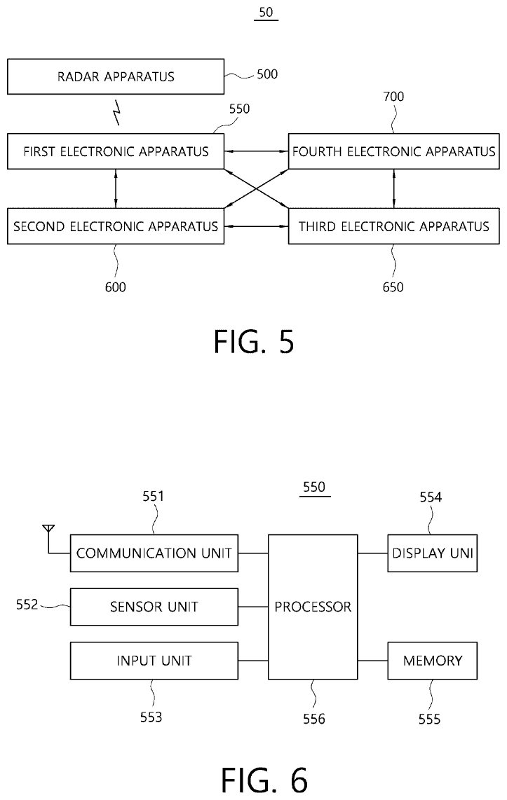

FIG. 5 is a diagram illustrating main configurations of a system for recognizing a nearby object according to another embodiment of the present disclosure.

Referring to FIG. 5, a system 50 according to another embodiment of the present disclosure may include a radar apparatus 500 and a plurality of electronic apparatus 600, 650, and 700, and the radar apparatus 500 may be connected to a first electronic apparatus 550. In this case, the radar apparatus 500 may be provided in a personal mobility device (not shown), and the first electronic apparatus 550 may be a mobile terminal, such as a smartphone, etc., carried by a user using the personal mobility device (hereinafter referred to as a first personal mobility device). In this case, the second electronic apparatus 600 to the fourth electronic apparatus 700, similar to the first electronic apparatus 550, may be mobile terminals, such as a smartphone, etc., carried by users using personal mobility devices (hereinafter referred to as second to fourth personal mobility devices), and may communicate with radar apparatus provided in the second to fourth personal mobility devices, respectively.

The radar apparatus 500 may include a radar sensor unit (not shown) and a BLE communication unit (not shown). The radar apparatus 500 may identify whether there is at least one object located in front of the first personal mobility device and the distance between the radar apparatus 500 and the object that are identified by the radar sensor unit, and then transmit a result of the identification to the first electronic apparatus 550. To this end, the radar apparatus 500 may perform BLE wireless communication with the first electronic apparatus 550 through the BLE communication unit.

The first electronic apparatus 550 generates first surrounding information including information indicating whether there is at least one object located in front of the first personal mobility device and the distance between the radar apparatus 500 and the object that are received from the radar apparatus 500. The first electronic apparatus 550 integrates the first surrounding information with second surrounding information, which is received from the second electronic apparatus 600 to the fourth electronic apparatus 700 of users using at least one other personal mobility devices, for example, second to fourth personal mobility devices, through a short-distance communication network and displays a notification message related to at least one object. In this case, main configurations of the first electronic apparatus 550 will be described in more detail using FIG. 6 below. FIG. 6 is a diagram illustrating main configurations of an electronic apparatus for recognizing a nearby object according to another embodiment of the present disclosure.

Referring to FIG. 6, the electronic apparatus 550 according to another embodiment of the present disclosure may include a communication unit 551, a sensor unit 552, an input unit 553, a display unit 554, a memory 555, and a processor 556. In addition, in the embodiment of the present disclosure, the main configurations shown in FIG. 6 are illustrated as main configurations of the first electronic apparatus 550, but the second electronic apparatus 600 to the fourth electronic apparatus 700 may also be implemented with the same configurations shown in FIG. 6.

The communication unit 551 communicates with the radar apparatus 500 using BLE, and forms a BLE mesh network, which is a short-range communication network, with the second electronic apparatus 600 to the fourth electronic apparatus 700. The communication unit 551 may receive second surrounding information from the second to fourth electronic apparatus 600 to 700 through BLE communication, and transmit first surrounding information generated by the first electronic apparatus 550 to the second electronic apparatus 600 to the fourth electronic apparatus 700. Additionally, the communication unit 551 may transmit integrated surrounding information in which the first surrounding information is integrated with the second surrounding information to the second electronic apparatus 600 to the fourth electronic apparatus 700.

Additionally, the communication unit 551 may receive a signal transmitted from a GPS satellite, calculate a current location of a user, and transmit the current location of the user to the processor 556.

The sensor unit 552 may include an accelerometer, a gyroscope, a magnetometer, and an altimeter. The sensor unit 552 may identify the moving direction and the moving speed of the first electronic apparatus 550 and transmit the moving direction and the moving speed of the first electronic apparatus 550 to the processor 556.

The input unit 553 generates input data in response to user input of the first electronic apparatus 550. To this end, the input unit 553 may include input devices, such as a keyboard, a mouse, a keypad, a dome switch, a touch panel, touch keys, and buttons.

The display unit 554 outputs output data according to the operation of the first electronic apparatus 550. To this end, the display unit 554 may include a display apparatus, such as a liquid crystal display (LCD), a light emitting diode (LED) display, an organic light emitting diode (OLED) display, and the like. In addition, the display unit 554 may be implemented in the form of a touch screen in combination with the input unit 553.

The memory 555 may store various programs for operating the first electronic apparatus 550. The memory 555 may store a unique number assigned to the radar apparatus 500. The memory 555 may store a program for generating integrated surrounding information by integrating the first surrounding information with the second surrounding information. In particular, the memory 555 may store a program for identifying the same object in the first surrounding information and the second surrounding information. To this end, the memory 555 may store an application including the corresponding programs.

The processor 556 may, when the start of driving of the first personal mobility device is confirmed, identify the current location information of the first personal mobility device (hereinafter referred to as the first electronic apparatus 550) from the communication unit 551. The processor 556 may identify the current moving direction and the current moving speed of the first electronic apparatus 550 from the sensor unit 552.

The processor 556 identifies whether there is at least one object located in front of the first personal mobility device and the distance between the first personal mobility device and the object that are received from the radar apparatus 500. The processor 556 generates first surrounding information including the current location information of the first electronic apparatus 550 received from the communication unit 551, the current moving direction and the current moving speed of the first electronic apparatus 550 that are received from the sensor unit 552, the at least one detected object, and the unique number assigned to the radar apparatus 500.

The processor 556, upon receiving second surrounding information from at least one electronic apparatus through the BLE mesh network, integrates the first surrounding information with the second surrounding information to generate integrated surrounding information. For example, the processor 556 may receive second surrounding information from the second electronic apparatus 600, the third electronic apparatus 650, and the fourth electronic apparatus 700 forming the BLE mesh network with the first electronic apparatus 550. In this case, the second surrounding information may include current location information, a current moving direction, a current moving speed, at least one detected object of the second electronic apparatus 600 to the fourth electronic apparatus 700, and a unique number assigned to the radar apparatus of each of the second electronic apparatus 600 to the fourth electronic apparatus 700.

The processor 556 identifies the unique numbers of the first to fourth radar apparatus included in the first surrounding information and the second surrounding information. The first surrounding information and the second surrounding information may be updated in real time according to the movement of the first to fourth electronic apparatus 550 to 700. When the same unique number is identified when integrating the first surrounding information and the second surrounding information, the processor 556 may delete surrounding information other than the most recently received surrounding information, thereby maintaining the most recent surrounding information.

Additionally, the processor 556 may identify equivalency of an object based on location information of the object included in the first surrounding information and the second surrounding information. The processor 556 may, when it is identified as a result of identification of the location information of the object included in the first surrounding information and the second surrounding information that objects included in the first surrounding information and the second surrounding information are the same object, merge the objects into one object, and when the objects are not identified to be the same object, maintain the objects as separate objects to generate the integrated surrounding information.

The processor 556 may, upon identifying an electronic apparatus capable of receiving the integrated surrounding information within a range of the BLE mesh network through communication with the communication unit 551, such as the second electronic apparatus 600 to the fourth electronic apparatus 700, transmit the integrated surrounding information to the identified electronic apparatus.

The processor 556 may, when at least one object identified in the integrated surrounding information is identified to be a dangerous object based on the current moving direction and the current moving speed of the first personal mobility device, generate a notification message and transmit the generated notification message to the display unit 554.

The second electronic apparatus 600 to the fourth electronic apparatus 700 form a BLE mesh network with the first electronic apparatus 550. The second electronic apparatus 600 to the fourth electronic apparatus 700 may each generate second surrounding information including location information about at least one object located in the moving direction thereof, and transmit the generated second surrounding information to all electronic apparatus included in the BLE mesh network through BLE communication. Additionally, the second electronic apparatus 600 to the fourth electronic apparatus 700 may receive surrounding information from other electronic apparatus and may receive integrated surrounding information from the first electronic apparatus 550.

As is apparent from the above, the apparatus and method for recognizing a nearby object in a personal mobility device according to the present disclosure can allow information about an object obtained from other personal mobility devices to be integrated and identified using a radar sensor and a short-range communication network, thereby reducing accident rates caused by a failure to recognize an object.

In addition, the apparatus and method for recognizing a nearby object in a personal mobility device according to the present disclosure can allow information about an object obtained from other personal mobility devices to be integrated and identified through a network formed using BLE, thereby enabling operation without a separate central processing system in a low-power environment.

Specific embodiments are shown by way of example in the specification and the accompanying drawings and are merely intended to aid in the explanation and understanding of the technical spirit of the present disclosure rather than limiting the scope of the present disclosure. Those of ordinary skill in the technical field to which the present disclosure pertains should be able to understand that various modifications and alterations may be made without departing from the technical spirit or essential features of the present disclosure.

1. An apparatus for recognizing a nearby object, the apparatus comprising:
a memory in which at least one instruction is stored; and
at least one processor configured to execute the at least one instruction stored in the memory,
wherein the processor is configured to generate first surrounding information including an object detected by a radar sensor, and integrate the first surrounding information with second surrounding information received from at least one other personal mobility device through a short-range communication network to generate a notification message related to at least one object.

2. The apparatus of claim 1, wherein the processor identifies a current location of a personal mobility device.

3. The apparatus of claim 2, wherein the processor identifies a moving direction and a moving speed of the personal mobility device.

4. The apparatus of claim 3, wherein the first surrounding information and the second surrounding information includes the current location, the moving direction, and the moving speed, includes location information of the object identified based on the current location and the moving direction, and includes a unique number assigned to the radar sensor.

5. The apparatus of claim 4, wherein the short-distance communication network is a mesh network formed based on Bluetooth Low Energy (BLE).

6. The apparatus of claim 5, wherein, upon the same unique number being identified when integrating the first surrounding information with the second surrounding information, the processor deletes surrounding information other than most recently received surrounding information.

7. The apparatus of claim 6, wherein the processor identifies equivalence of an object based on the location information of the object included in the first surrounding information and the second surrounding information.

8. The apparatus of claim 7, wherein, when at least one object is identified as the same object based on the location information of the object, the processor merges the at least one object into one object.

9. The apparatus of claim 8, wherein the processor transmits the integrated surrounding information to at least one other personal mobility device located within a range of the short-range communication network.

10. The apparatus of claim 9, wherein the processor generates the notification message when the at least one object is determined to be a dangerous object based on the current location, the moving direction, and the moving speed of the personal mobility device.

11. A method of recognizing a nearby object, the method comprising:
generating, by a processor, first surrounding information including an object detected by a radar sensor;
receiving, by the processor, second surrounding information from at least one other personal mobility device through a short-range communication network;
integrating, by the processor, the first surrounding information with the second surrounding information; and
generating, by the processor, a notification message related to at least one object identified based on the integrated surrounding information.

12. The method of claim 11, wherein the generating of the first surrounding information includes identifying a current location of a personal mobility device.

13. The method of claim 12, wherein the generating of the first surrounding information includes identifying a moving direction and a moving speed of the personal mobility device.

14. The method of claim 13, wherein the generating of the first surrounding information includes generating the first surrounding information including: the current location, the moving direction, and the moving speed; location information of the object identified based on the current location and the moving direction; and a unique number assigned to the radar sensor.

15. The method of claim 14, wherein the receiving of the second surrounding information includes receiving the second surrounding information through a mesh network formed based on Bluetooth Low Energy (BLE), which is the short-distance communication network.

16. The method of claim 15, wherein the integrating of the first surrounding information with the second surrounding information includes
upon the same unique number being identified when integrating the first surrounding information with the second surrounding information, deleting surrounding information other than most recently received surrounding information.

17. The method of claim 16, wherein the integrating of the first surrounding information with the second surrounding information includes
identifying equivalence of an object based on the location information of the object included in the first surrounding information and the second surrounding information.

18. The method of claim 17, wherein the integrating of the first surrounding information with the second surrounding information includes
when at least one object is identified as the same object based on the location information of the object, merging the at least one object into one object.

19. The method of claim 18, further comprising, after the integrating of the first surrounding information with the second surrounding information,
transmitting, by the processor, the integrated surrounding information to at least one other personal mobility device located within a range of the short-range communication network.

20. The method of claim 19, wherein the generating of the notification message includes generating the notification message when the at least one object is determined to be a dangerous object based on the current location, the moving direction, and the moving speed of the personal mobility device.
